(19) United States
(12) Patent Application Publication
(10) Pub. No.: US 2023/0399826 A1
(43) Pub. Date: Dec. 14, 2023

(54) HYDRANT PUMPER CAP COMMUNICATION ASSEMBLY

(71) Applicant: Mueller International, LLC, Atlanta, GA (US)

(72) Inventors: Haedoo Choi, Sandy Springs, GA (US); Timothy J. Mitchell, Hixson, TN (US); Rachel Rifenberg, Prattville, AL (US); Christopher Joseph Duckett, Guntersville, AL (US); Justin Blaine Childress, Albertville, AL (US); Emil Simion, Smyrna, GA (US); Diego Aguilera, Chattanooga, TN (US)

(21) Appl. No.: 18/208,081

(22) Filed: Jun. 9, 2023

Related U.S. Application Data
(60) Provisional application No. 63/351,230, filed on Jun. 10, 2022.

(51) Int. Cl. E03B 9/06; A62C 37/50; A62C 35/20

(52) U.S. Cl. CPC E03B 9/06; A62C 37/50; A62C 35/20; H04W 4/38

(57) ABSTRACT

A nozzle cap for a hydrant can include an inner cap securably engageable with a nozzle of the hydrant, the nozzle configured to connect a fire hose to the hydrant; a communications hub positioned adjacent to the inner cap; and a plug plugging an opening defined in the inner cap and securably engaged with the inner cap, the plug including a material that allows transmission of a wireless signal through the material.

### REFERENCE TO RELATED APPLICATIONS

This application claims the benefit of U.S. Provisional Application No. 63/351,230, filed Jun. 10, 2022, which is hereby specifically incorporated by reference herein in its entirety.

### TECHNICAL FIELD

### Field of Use

This disclosure relates to fire hydrants. More specifically, this disclosure relates to hydrants and portions thereof able to collect and relay system data through a pumper cap or nozzle cap thereof.

### Related Art

Proper maintenance of a water system can be facilitated by knowledge about each aspect of the system—particularly knowledge regarding water pressure and other characteristics of flow in the line. One approach includes sensing these characteristics from inside a cavity of the hydrant with a sensor. While transmitting a signal and/or related information to a remote location (i.e., separate from the hydrant) can be beneficial to a user, transmitting a signal from the sensor through the pumper cap or nozzle cap can be difficult because the nozzle cap is usually metallic and thus typically impermeable by a wireless signal. At the same time, the pressure inside a hydrant can be relatively high (e.g., 300 psig) and every opening including that covered by the pumper cap or the nozzle cap can be the source of a problematic leak if not adequately sealed.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a nozzle cap for a hydrant, the nozzle cap comprising: an inner cap securably engageable with a nozzle of the hydrant, the nozzle configured to connect a fire hose to the hydrant; a communications hub positioned adjacent to the inner cap; and a plug plugging an opening defined in the inner cap and securably engaged with the inner cap, the plug comprising a material that allows transmission of a wireless signal through the material.

In a further aspect, disclosed is a method of using a hydrant, the method comprising: sending a signal from a sensing device of the hydrant, the sensing device extending at least partly through a main valve of the hydrant; and receiving the signal through a plug plugging an opening defined in a portion of a nozzle cap of the hydrant and securably engaged with the portion of the nozzle cap, the plug comprising a material that allows transmission of a wireless signal through the material.

In yet another aspect, disclosed is a method of using a hydrant in a fluid distribution system, the method comprising: measuring a strength of a wireless signal received at a communications hub positioned in a nozzle cap of the hydrant from a sensing device positioned elsewhere in the hydrant; and determining whether a fluid intended to be contained in the fluid distribution system is in an interior cavity of the hydrant based on the strength of the wireless signal.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a side view of a hydrant in accordance with one aspect of the current disclosure.

FIG. 2 is a sectional view of the hydrant of FIG. 1 taken along line 2-2 of FIG. 1.

FIG. 3A is a top inside perspective exploded view of a nozzle cap of the hydrant of FIG. 13.

FIG. 3B is a top outside perspective exploded view of the nozzle cap of FIG. 3A.

FIG. 4 is a sectional perspective view of the nozzle cap of the hydrant of FIG. 13 taken along line 4-4 of FIG. 13.

FIG. 5 is a sectional view of the nozzle cap of the hydrant of FIG. 13 taken along line 4-4 of FIG. 13.

FIG. 6 is an axial end view of a head or first end of a plug of the nozzle cap of FIG. 4.

FIG. 7 is an axial end view of a tail or second end of the plug of FIG. 6.

FIG. 8 is a side view of the plug of FIG. 6.

FIG. 9 is a detail side view of the plug of FIG. 6 taken from detail 9 of FIG. 8.

FIG. 10 is a sectional view of the plug of FIG. 6 taken along line 10-10 of FIG. 7.

FIG. 11 is an outside perspective view of an outside end or second end of the inner cap of the nozzle cap of FIG. 4 showing also the plug of FIG. 6.

FIG. 12 is an inside perspective view of an inside end or first end of the inner cap of FIG. 11 shown with the plug of FIG. 6 and a tool for removal and installation of the plug.

FIG. 13 is the hydrant of FIG. 1 in accordance with other aspects of the current disclosure and an electronic device in communication the hydrant.

FIG. 14 is a sectional perspective view of the nozzle cap of the hydrant of FIG. 13 taken along line 14-14 of FIG. 13 showing the plug and a cap seal in accordance with other aspects of the current disclosure.

FIG. 15 is a sectional view of the nozzle cap of the hydrant of FIG. 13 taken along line 14-14 of FIG. 13 showing the plug and the inner cap and various other components in accordance with other aspects of the current disclosure.

FIG. 16 is an inside perspective view of an inside end or first end of the inner cap and the plug of FIG. 15.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” and the phrase “one or more of A and B” as used herein mean “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the hydrant nearest to a main nozzle; “rear” is that end of the hydrant that is opposite or distal the front; “left” is that which is to the left of or facing left from a person facing towards the front; and “right” is that which is to the right of or facing right from that same person facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

In one aspect, a nozzle cap of a hydrant and associated methods, systems, devices, and various apparatuses are disclosed herein. In one aspect, the nozzle cap can comprise a plug, which can be configured to allow passage of a wireless signal.

The nozzle cap of a typical hydrant comprises a base made from ductile iron. A sensing device of a new “smart” hydrant, which can be located at a bottom end of a lower stem of the hydrant as disclosed herein and as disclosed in U.S. application Ser. No. 16/434,915, filed on Jun. 7, 2019, and issued as U.S. Pat. No. 10,968,609 on Apr. 6, 2021, can communicate via a wireless communications technology (e.g., Bluetooth® technology from Bluetooth SIG, Inc.) with devices located internal to the hydrant 1000, e.g., a communications hub located under a bonnet of the hydrant, or devices located external to the hydrant 1000. Such communication with a communications hub in the nozzle cap as typically configured is, however, generally not possible due to the structure of the nozzle cap and, more specifically, blockage of the signal by the material forming the typical nozzle cap. Using the structures and methods disclosed herein, the sensing device can communicate with a communications hub in the nozzle cap.

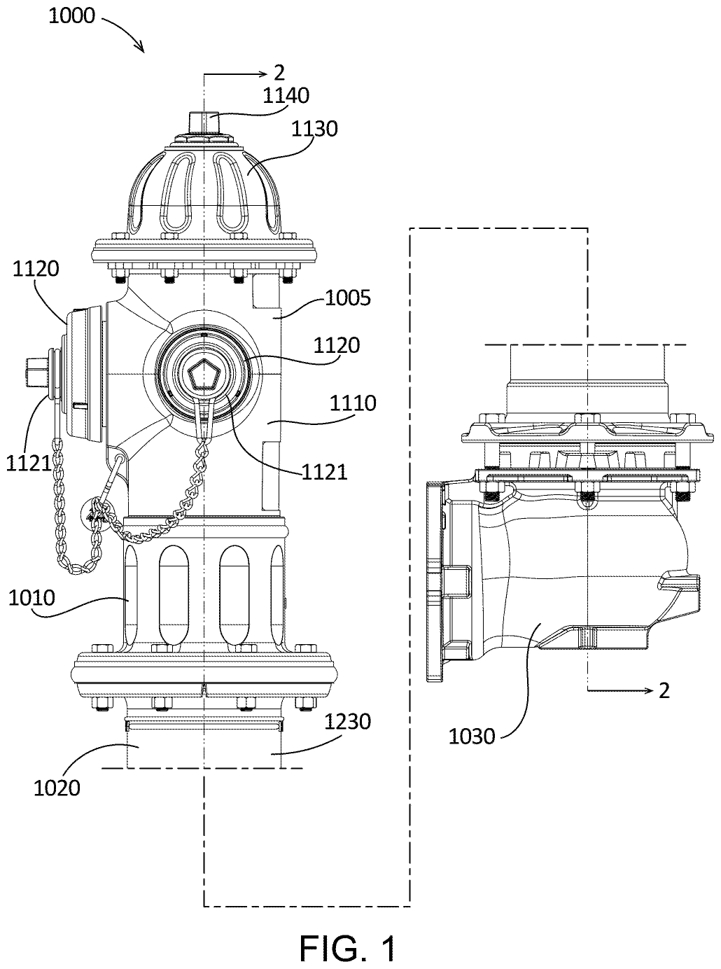

FIG. 1 is a side view of a hydrant 1000 in accordance with one aspect of the current disclosure A fluid distribution system such as, for example and without limitation, a municipal water system, can comprise the hydrant 1000, which can be a fire hydrant. As shown, the hydrant 1000 can comprise a hydrant body 1005, which can comprise an upper barrel assembly 1010, a lower barrel assembly 1020, and a shoe 1030. In various aspects, the upper barrel assembly 1010 of the hydrant 1000 can be positioned above ground, the lower barrel assembly 1020 can be at least partially subterranean, and the shoe 1030 can be connected to the fluid distribution system and can be installed in the ground.

The upper barrel assembly 1010 can comprise an upper barrel 1110, one or more nozzles 1120, one or more nozzle caps 1121, and a bonnet 1130. The one or more nozzles 1120 can be configured to connect fire hoses or other equipment. The nozzle caps 1121 can cover the nozzles 1120 and can be adapted or configured to be removable to provide selective access to the nozzles 1120. The bonnet 1130 can be secured to the upper barrel 1110. As shown, the bonnet 1130 can be attached to the upper barrel 1110 by bolts. The upper barrel assembly 1010 can be connected or attached to the lower barrel assembly 1020, which can be with bolts. The lower barrel assembly 1020 can comprise a lower barrel 1230.

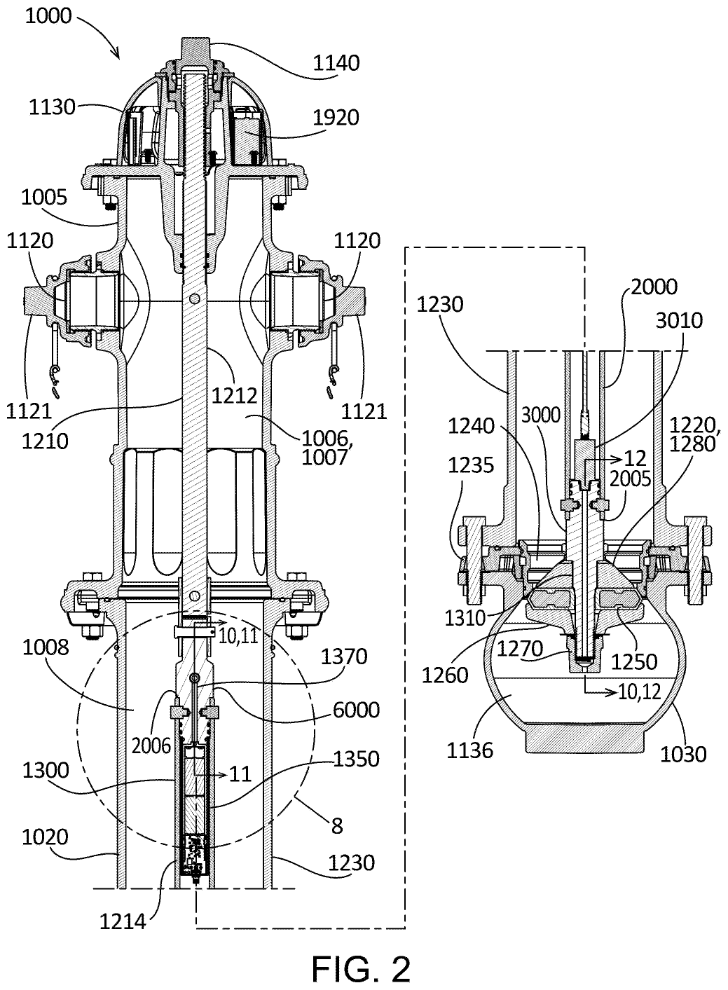

FIG. 2 is a sectional view of the hydrant 1000 of FIG. 1 taken along line 2-2 of FIG. 1. The hydrant body 1005 can define an interior cavity 1006. More specifically, the upper barrel assembly 1010 can define an upper portion 1007 of the interior cavity 1006; and the lower barrel assembly 1020 can define a lower portion 1008 of the interior cavity 1006. The shoe 1030 can define a shoe cavity 1136. A spacer 1235 can be positioned between the lower barrel 1230 and the shoe 1030.

An operating stem 1210 can be positioned within the hydrant 1000 and can extend from the bonnet 1130 to a valve 1220, which can be a valve assembly and can be positioned proximate to or at a junction between the shoe 1030 and the lower barrel assembly 1020. The operating stem 1210 can extend through each of the bonnet 1130 and the valve 1220. The operating stem 1210 can be actuated by an operating nut 1140 at a top end of the bonnet 1130. More specifically, the operating stem 1210 can be configured to open and close the valve upon rotation of the operating nut 1140 about a stem axis defined by the operating stem 1210. The interior cavity 1006 of the hydrant 1000 can be in fluid communication with the shoe cavity 1136 when the valve 1220 is open, and the valve 1220 can be configured to seal the interior cavity 1006 from the shoe cavity 1136 when the valve 1220 is closed.

The valve 1220 can comprise one or more components. More specifically, the valve 1220 can comprise a valve member 1250. The valve member 1250 can comprise a rigid or semi-rigid disc. The valve member 1250 can be encapsulated in a flexible material or other covering or coating. In various aspects, the valve member 1250 can be coated in a sealing material such as rubber or elastomer. When the valve 1220 is closed, the valve member 1250 can seal against a valve seat 1240, thereby preventing water from ascending into or otherwise entering the lower barrel 1230. The valve 1220 can comprise a valve retainer 1260, which can be located adjacent to and below a first end or bottom end of the valve member 1250. More specifically, the valve retainer 1260 can push or press the valve member 1250 against the valve seat 1240. A valve nut 1270 can be attached or connected to an end of the operating stem 1210 to secure the valve member 1250 and the valve retainer 1260 to the operating stem 1210 and to push or press the valve retainer 1260 against the valve member 1250. A reinforcement member 1280 can be attached to or located proximate to a second end or top end of the valve member 1250, which can be opposite from the first end thereof, to help fix the location of the valve member 1250 and to prevent movement of the valve member 1250 due to the high water pressure inside the shoe cavity 1136.

In various aspects, the hydrant 1000 can comprise a sensing device 1300. As shown, the sensing device 1300 can comprise a sensor 3010, at least one battery 1350, and an antenna 1370. The operating stem 1210 can comprise an upper stem 1212 and a lower stem 1214. The lower stem 1214 can comprise a lower stem top end 6000. The sensing device 1300 can be housed within the operating stem 1210 and, more specifically, the lower stem 1214. In some aspects, by incorporating the sensing device 1300 into the hydrant 1000—without affecting operation of the hydrant 1000—one can avoid the expense of an independent installation and can avoid taking equipment useful for public safety out of temporary service.

In some aspects, the sensor 3010 is a pressure sensor for measuring a pressure of the fluid in the disclosed fluid distribution system. In other aspects, the sensor 3010 is a sensor measuring any one of a number of other fluid properties, including, for example and without limitation, temperature. The sensor 3010 can be potted with potting material configured to seal a portion of the sensor 3010 containing electronics against water intrusion.

The lower stem 1214 can comprise a lower stem bottom end 3000, which can be opposite from the lower stem top end 6000 on the lower stem 1214. The lower stem 1214 can comprise a stem pipe 2000, which can join the lower stem bottom end 3000 and the lower stem top end 6000. The sensing device 1300 can be at least partly housed within the stem pipe 2000. In some aspects, as shown, the lower stem bottom end 3000 can be coupled to the stem pipe 2000 at a lower end or first end 2005 of the stem pipe 2000 and the lower stem top end 6000 can be coupled to the stem pipe 2000 at an upper end or second end 2006 of the stem pipe 2000. As shown, each of the valve member 1250, the valve retainer 1260, and the reinforcement member 1280 can comprise features allowing the sensing device 1300 to have access to the fluid in the fluid distribution system. With such access, the sensing device 1300 can sense properties of the fluid. The operating stem 1210 and, more specifically, the lower stem bottom end 3000 can comprise a hollow vessel or vein 1310 configured to expose the sensor 3010 to the fluid of the fluid distribution system whose properties are to be measured.

In some aspects, the construction and arrangement of the hydrant 1000 and components thereof including, for example and without limitation, the sensing device 1300 can be as disclosed in U.S. application Ser. No. 16/434,915, filed on Jun. 7, 2019, and issued as U.S. Pat. No. 10,968,609 on Apr. 6, 2021, or as disclosed in U.S. application Ser. No. 16/435,004, filed on Jun. 7, 2019, each of which is hereby incorporated by reference herein in its entirety. In some aspects, the hydrant 1000 can comprise a communications hub 1920 (also disclosed within U.S. application Ser. Nos. 16/434,915 and 16/435,004), which can be housed within the bonnet 1130 and can receive, process, and send elsewhere a signal received wirelessly from the sensing device 1300 via the antenna 1370. In some aspects, the connection between the sensing device 1300 and the communications hub 1920 can be a wired connection.

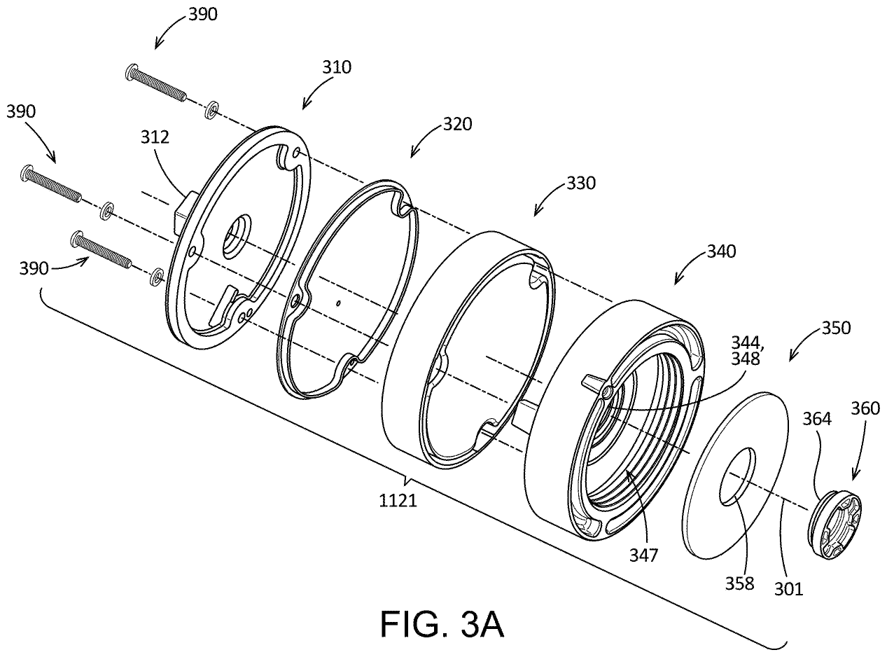

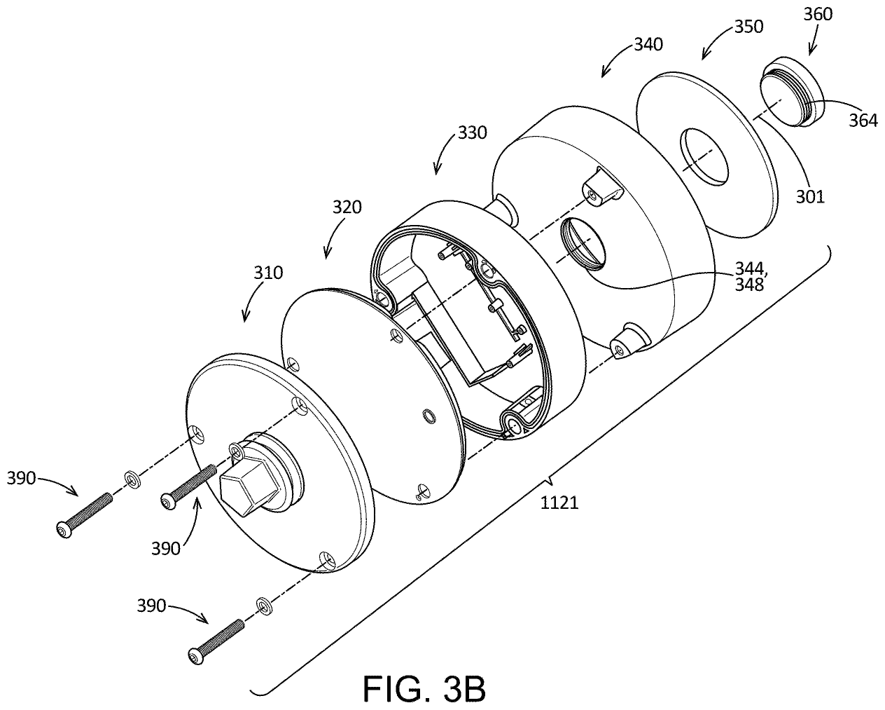

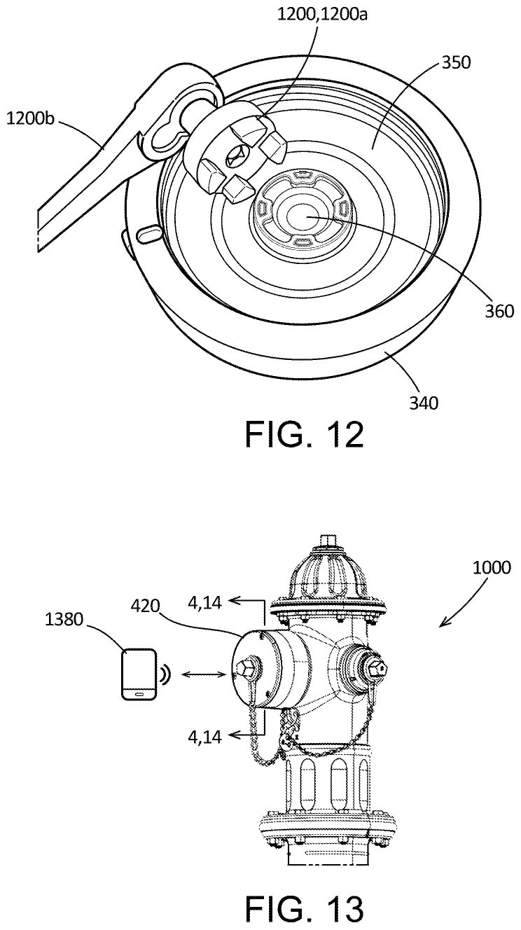

FIG. 3A is a top inside perspective exploded view of a nozzle cap 1121 of the hydrant 1000 of FIG. 13, which can comprise or define one or all of the features of the hydrant 1000 of FIG. 1, and FIG. 3B is a top outside perspective exploded view of the nozzle cap 1121. The nozzle cap assembly or nozzle cap 1121, which can be a pumper cap, can comprise an outer bumper cap or outer cap 310. The outer cap 310 can comprise a protrusion 312 defining a polygonal (e.g., pentagonal) shape configured to be engaged with a matching tool 1200 (shown in FIG. 12) for tightening or loosening the nozzle cap 1121 during installation or removal, respectively. The nozzle cap 1121 can comprise an outer cover or cover 320, which can be positioned inside the outer cap 310 on the nozzle cap 1121 relative to the hydrant, i.e., between the reference part (here, the outer cap 310) and the interior cavity 1006 (shown in FIG. 2) and/or the corresponding nozzle 1120 (shown in FIG. 1) of the hydrant 1000. The nozzle cap 1121 can comprise an electronics housing or housing 330, which can be positioned inside the cover 320. The nozzle cap 1121 can comprise an inner housing or inner bumper cap or inner cap 340, which can be positioned inside the housing 330. The nozzle cap 1121 can comprise an inner housing or inner bumper cap or inner cap 340, which can be positioned inside the housing 330. The nozzle cap 1121 can comprise a cap gasket or cap seal 350, which can be positioned inside the inner cap 340. The cap seal 350 can define an opening 358. The nozzle cap 1121 can comprise a pressure plug or plug 360, which can be positioned inside the cap seal 350.

Any one or more of the outer cap 310, the cover 320, the housing 330, the inner cap 340 can be formed from a metallic or non-metallic material. In some aspects, even the cap seal 350 can be made from a metallic or non-metallic material and can in any case be configured to seal between the nozzle cap 1121 and the nozzle 1120 upon tightening of the nozzle cap 1121 against the nozzle 1120. In some aspects, more specifically, the cap seal 350 can be made from a rubber or rubber-like material and can be deformable and elastic. The plug 360 can be a non-metallic material and generally must be formed from a material that allows passage or transmission of a wireless signal. To “allow” passage or transmission of the wireless signal means that the material permits passage or transmission of the wireless signal therethrough to a sufficient level that the wireless signal is usable for its intended purpose. Each of the outer cap 310, the cover 320, the housing 330, the inner cap 340, the cap seal 350, and the plug 360 can be aligned and assembled along an axis 301. One or more of the outer cap 310, the cover 320, the housing 330, the inner cap 340, the cap seal 350, and the plug 360 can be assembled to each other with one or more fasteners. In some aspects, the outer cap 310, the cover 320, the housing 330, and the inner cap 340 can be assembled and secured to each other with one or more fasteners 390 such as, for example and without limitation, the threaded fasteners and washers shown. In some aspects, one or more of these and other components can be assembled with an adhesive or adhesion process. In some aspects, no adhesive or adhesion process is required per se, and gravity, a friction fit, and/or pressure between adjacent parts will suffice.

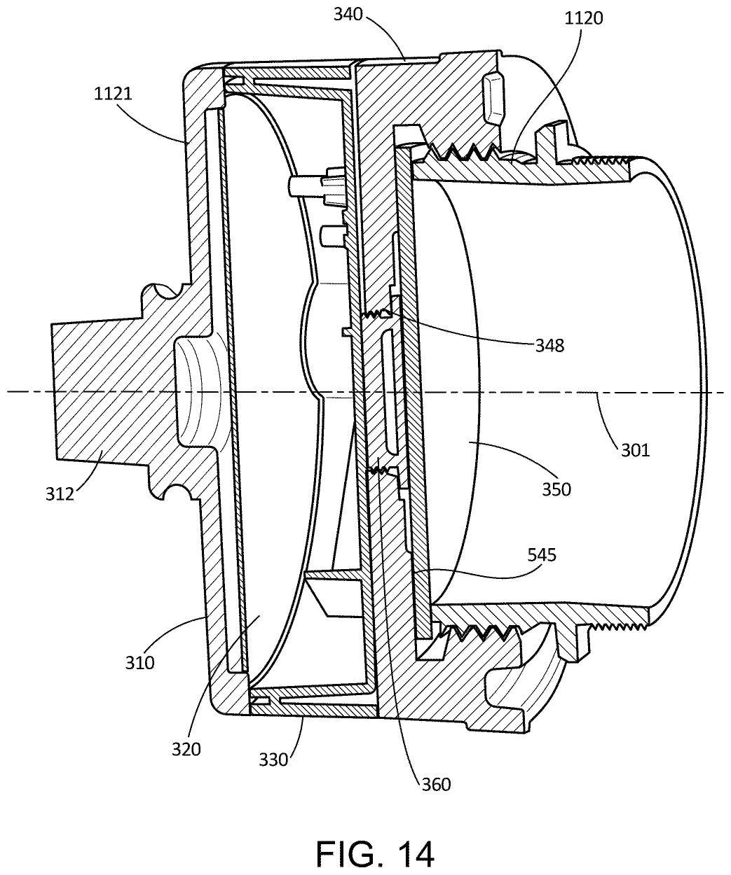

The outer cap 310 can be used to manipulate the nozzle cap (e.g., with the tool 1200 as noted above), and the inner cap 340 can be used to directly engage the nozzle 1120 with, e.g., a threaded portion as shown configured to engage a matching threaded portion on the nozzle 1120. To facilitate receipt of the nozzle 1120, the inner cap 340 can define a cavity 347 and thereby can define the threaded portion and be configured to receive the protruding nozzle 1120 therein. The inner cap 340 can further define a bore or opening 348, which can itself define a threaded portion 344 and can be configured to receive a threaded portion 364 of the plug 360 therein. The plug 360 can prevent passage of the fluid, e.g., water, through an opening defined by the nozzle 1120 but at the same time can allow passage of a wireless signal from the sensing device 1300 located elsewhere in the hydrant 1000. In some aspects, the plug 360 can be secured to the inner cap 340 without the threaded portions 344,364 and can instead use another fastening method (e.g., with a gland and/or or separate fasteners or an integral fastening method not requiring threads per se). In some aspects, for example, the plug 360 can incorporate a quarter-turn design in which the plug engages axially with the inner cap 340 at a particular rotational position and then rotates 90 degrees (or some other desirable angle) to a lock position. In some aspects, the plug 360 can involve a press fit installation with minimal machining (e.g., to a specified diameter but without threads, and the plug 360 molded or machined to match with a slight interference fit as desired) or, as discussed below with respect to FIG. 14, with no machining.

One or both of the housing 330 and the cover 320 can house a communications hub 420 comprising various electronic components, which can be configured to receive, process, and/or rebroadcast a signal from the sensing device 1300. More details on the communications hub 420 can be found in references to a communication hub in the applications incorporated by reference above, e.g., U.S. application Ser. No. 16/435,004. The communications hub 420 can facilitate receipt of a wireless signal from the sensing device 1300 and sending of the wireless signal elsewhere.

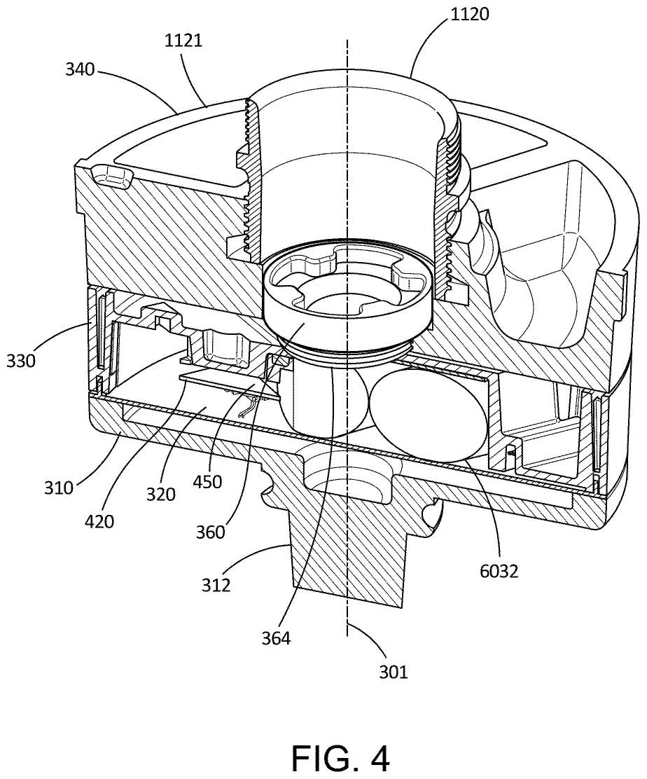

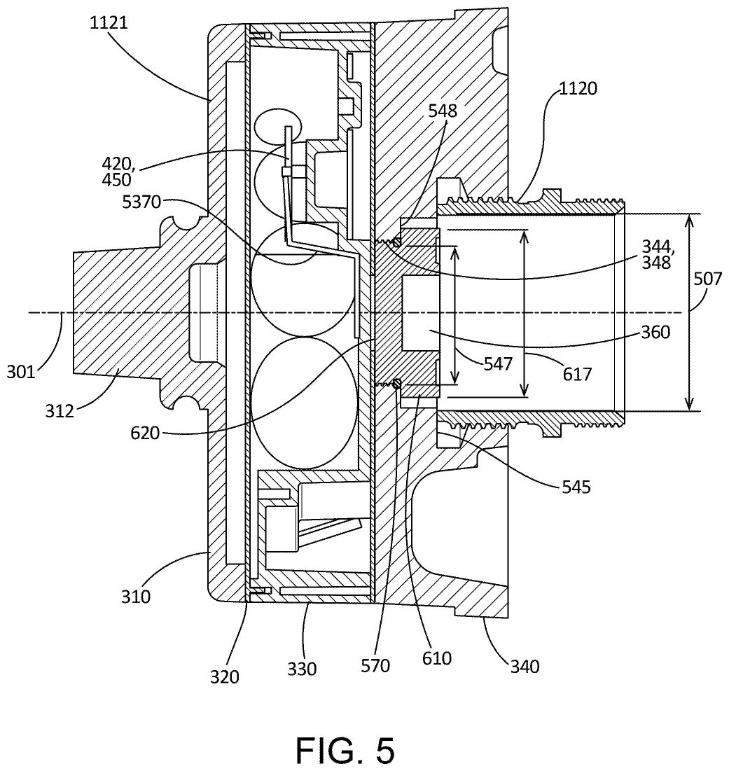

FIG. 4 is a sectional perspective view of the nozzle cap 1121 of the hydrant 1000 of FIG. 13 taken along line 4-4 of FIG. 13, and FIG. 5 is a sectional perspective view of the nozzle cap 1121 of the hydrant 1000 of FIG. 13 taken along line 4-4 of FIG. 13. The nozzle cap 1121 can be assembled as shown. More specifically, the plug 360 can be received within the opening 348 (shown in FIG. 3B) of the inner cap 340 and can be assembled to the inner cap 340. Again, as shown, the threaded portion 364 of the plug 360 can be received within the opening 348 and can be engaged to the threaded portion 344 of the inner cap 340. The nozzle cap 1121 can be assembled to the nozzle 1120, which is shown separated from the hydrant 1000 and, more specifically, the hydrant body 1005.

As shown in FIG. 5, the plug 360 need not interfere with the engagement of the nozzle cap 1121 with the nozzle 1120 because it can be made to sit substantially flush with an inside shoulder 545 defined in the inner cap 340 and partly defining the cavity 347 (shown in FIG. 3A) or, as also shown, a diameter 617 of the plug can be smaller than a diameter or more specifically, an inner diameter 507 of the nozzle 1120. To facilitate consistent placement of the plug 360 in the opening 348, e.g., in an axial direction as shown, a diameter 547 of the opening 348 can be smaller than the diameter 617 of the plug 360. More specifically, a main body or first portion 610 of the plug 360 can be received within a countersunk portion or recess 548 defined in the shoulder 545 of the inner cap 340, and a second portion 620 of the plug 360 can be received within the opening 348. As shown, the inside shoulder 545 can be that portion of the nozzle cap 1121 that engages with the nozzle 1120 and, more specifically, an outer axial end of the nozzle 1120. The nozzle cap 1121 can comprise a seal 570, which can be positioned between the plug 360 and the inner cap 340 and seal a connection or joint therebetween. In some aspects, the seal 570 can be an O-ring as shown. In some aspects, the seal 570 can be a flat gasket or any other suitable size and shape able to seal between the plug 360 and the inner cap 340. In some aspects, the plug 360 can be self-sealing (e.g., by a press fit configuration and/or choice of material and/or use of a liquid sealing material upon installation between the plug 360 and the inner cap 340). The nozzle cap 1121 can comprise a printed circuit board (PCB) or controller 450, which can control operation of a communications hub 420 and can be positioned inside the housing 330.

As also shown in FIG. 5, an antenna 5370 of the communications hub 420 can be positioned inside the nozzle cap 1121 and can, for example and without limitation, extend from the controller 450. More specifically, the antenna 5370 can be routed adjacent to the plug 360 to facilitate receipt and/or transmission of wireless signals through the plug 360. In some aspects, the antenna 5370 can be positioned close enough to the plug to receive such wireless signals. In some aspects, the antenna 5370 can be made to intersect a cylindrical space formed by projection of the opening 348 along the direction of the axis 301. The antenna 5370 can be configured to receive data wirelessly from an antenna of the sensing device 1300. The communications hub 420 can comprise a second antenna for sending data wirelessly to a network separate from the hydrant 1000, which can be a cloud-based server. The antenna 5370 can be a near-field communications antenna. In addition, a third antenna can receive data using GPS technology to identify the location of the hydrant 1000 in the system and also the time, which information can be used by the controller 450 including the aforementioned clock therein to time-stamp and otherwise synchronize and organize measured data.

The controller 450 can be in electrical communication with the aforementioned sensor 3010 of the lower stem bottom end 3000. The controller can be housed and sealed within the housing 330. The controller 450 can further comprise a clock for gathering, synchronization, and reporting of collected data.

The controller 450 can be attached to the surrounding structure by fasteners. In various aspects, the fasteners can be any fastener known in the art, including glue, welding, nails, mechanical locks, and mechanical fasteners, among others. In various aspects, the controller 450 can comprise various arrangements of electronic components.

The housing 330 and, more generally, the nozzle cap 1121 and the communications hub 420 can further comprise one or more batteries 6032. The one or more batteries 6032 can be in electrical communication with the controller 450. In some aspects, as shown, the housing 330 and, more generally, the communications hub 420 can comprise at least two batteries 6032, although any number of batteries can be present in other aspects.

Skipping ahead to FIG. 14, shown is a sectional perspective view of the nozzle cap 1121 of the hydrant 1000 of FIG. 13 taken along line 14-14 of FIG. 13 showing the plug 360 and the cap seal 350 in accordance with other aspects of the current disclosure. In some aspects, as shown, the cap seal 350 can be positioned on the inside of the plug 360 and cover the plug 360. Closing and sealing the inner cap 340 against the nozzle 1120 can thereby seal any and all gaps or openings in the shoulder 545 of the inner cap 340 such as any gaps or openings between the opening 348 and the plug 360. In such aspects, at least the mating portions of the plug 360 and the inner cap 340 can be used in an as-cast condition without further machining.

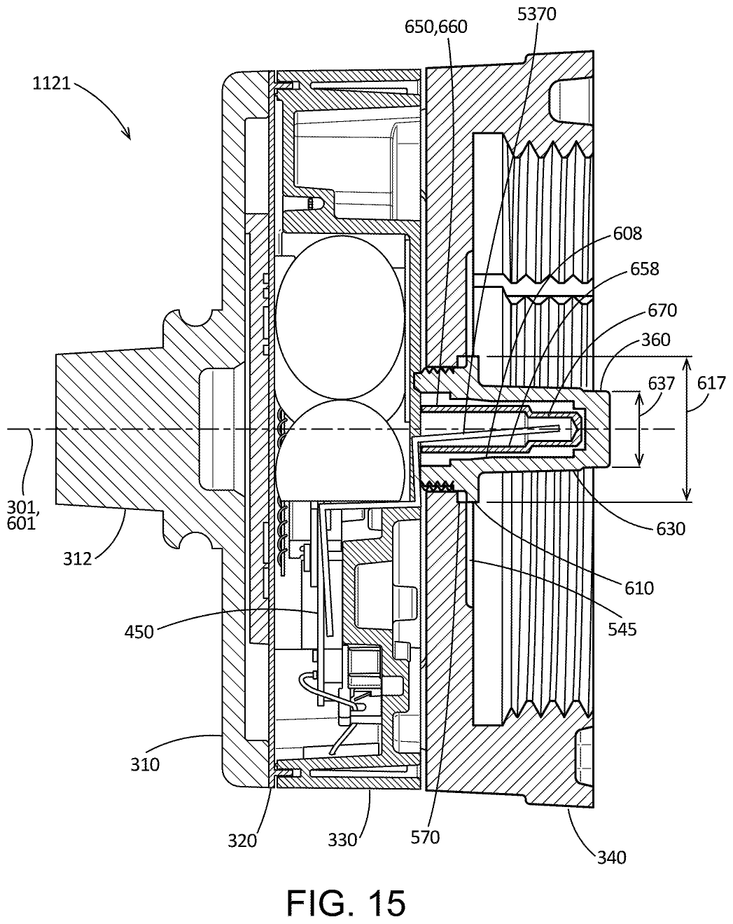

FIG. 15 is a sectional view of the nozzle cap 1121 of the hydrant 1000 of FIG. 13 taken along line 14-14 of FIG. 13 showing the plug 360 and the inner cap 340 and various other components in accordance with other aspects of the current disclosure. As shown, the plug 360 can comprise a third portion 630, which can extend from the first portion 610 in an axial direction with respect to the axis 301 away from the inner cap 340. The third portion 630 and the plug 360 can define a length in an axial direction with respect to the axis 301. This axial length can cause the plug 360 to extend as far as desired into the nozzle 1120 and, more generally, the hydrant 1000. As shown, the plug 360 can extend in an axial direction past an axial end of the inner cap 340. A diameter 637 of the third portion 630 can be less than the diameters 617 of the first portion and/or the diameter 627 (shown in FIG. 7) of the second portion 620.

The plug 360 and, more specifically as shown, each of the portions 610,620,630 thereof can define a cavity 608. The nozzle cap 1121 can comprise an antenna well or well 650, which can be received within the cavity 608 of the plug 360. The plug 360 and the well 650 can be formed from different materials and can have different properties (e.g., durometer or hardness). Like the plug 360, the well 640 can be formed from a non-metallic material and can be configured to not block a wireless signal as can be produced by the sensing device 1300. In some aspects, the well 650 can be simultaneously molded or otherwise formed with the plug 360. In some aspects, the well 650 can be formed and/or assembled separately from the plug 360. The well 650 can comprise a first portion 660 and a second portion 670 and can define a cavity 658. A diameter of the well can be smaller than the diameter 617, the diameter 627, and/or the diameter 637 of the plug 360. As shown, a diameter of the second portion 670 can be smaller than a diameter of the first portion 660.

The cavity 608 of the plug 360 and/or the cavity 658 of the well 650 can be sized and otherwise configured to receive a portion of the antenna 5370. In some aspects, as shown, a portion of the antenna 5370 distal from the controller 450 can extend into the cavity 608 and/or the cavity 658. By such extension, the antenna 5370 can be positioned closer to a center of the hydrant 1000 and, in any case, able to receive a wireless signal such as, for example and without limitation, that transmitted by the sensing device 1300. In some aspects, the well 650 can be received within the plug 360 without any fasteners or fastening material (e.g., adhesive). In other aspects, one or more fasteners or a fastening material can affix the well to the plug 360 or another adjacent structure.

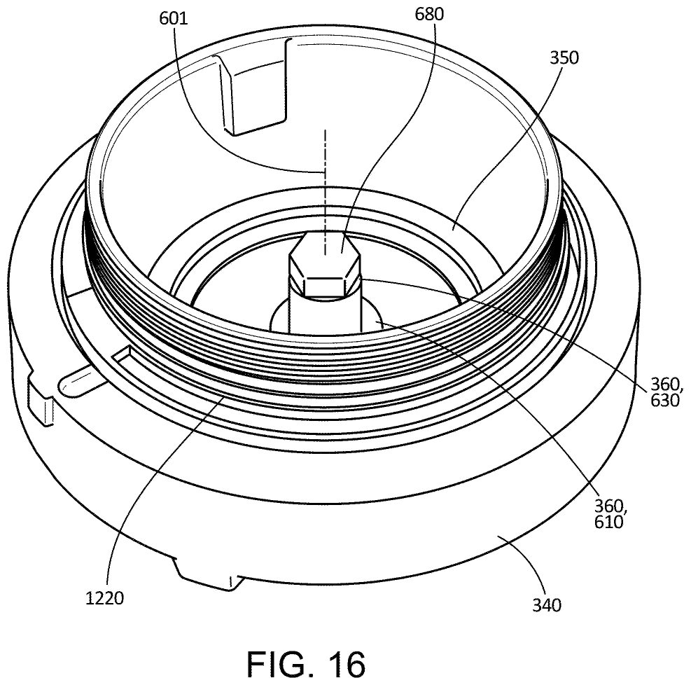

FIG. 16 is an inside perspective view of an inside end or first end of the inner cap 340 and the plug 360 of FIG. 14. As shown, the plug 360 can define the anti-rotation feature 680, which as noted below can protrude in an axially inward direction with respect to an axis 601 of the plug 360 from the first portion 610 of the plug 360, and an outer surface of the plug 360 and, more specifically, the anti-rotation feature 680 can define a polygonal shape. More specifically, the third portion 630 of the plug 360 can define a hexagonal shape and can be configured to be received within and manipulated by a tool (e.g., the tool 1200, shown in FIG. 12, with a socket sized to match). The tool can rotate the plug 360 during installation or removal.

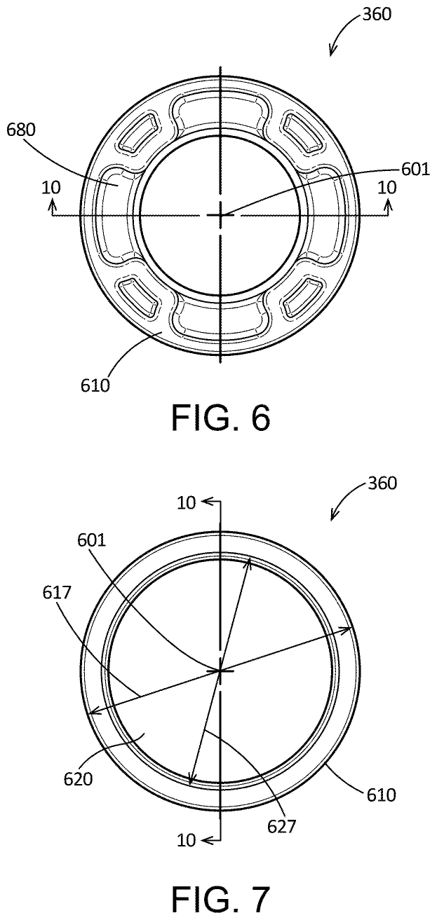

Skipping back to FIG. 6, shown is an axial end view of a head or first end of the plug 360 of the nozzle cap 1121 of FIG. 4, and FIG. 7 is an axial end view of a tail or second end of the plug of FIG. 6. The plug 360 can comprise the first portion 610 and the second portion 620 (shown in FIG. 7). In some aspects, the first portion 610 and the second portion 620 can be aligned along the axis 601 of the plug 360. In some aspects, the first portion 610 and the second portion 620 can be concentrically situated with respect to each other. The diameter 617 (shown in FIG. 7) of the first portion 610 of the plug 360 can be larger than a diameter 627 (shown in FIG. 7) of the second portion 620. Nominally, the diameter 617 of the plug 360 can match the diameter 547 (shown in FIG. 5) of the opening 348 (shown in FIG. 5) of the inner cap 340 (shown in FIG. 5). The first portion 610 can define or comprise a flange extending radially past the second portion 620.

In the first end or first portion 610, which can face towards a center of the hydrant 1000 when the nozzle cap 1121 is assembled to the hydrant 1000, the plug 360 can define an anti-rotation feature 680. In some aspects, the anti-rotation feature 680 can be sized to receive a standard drum wrench or bung wrench, which can be used to remove or install a plug or bung commonly used to seal an opening in a storage drum. In some aspects, the anti-rotation feature 680 can be sized to fit any tool, standard or custom, depending on the degree of tamper resistance desired by a user or manager of the system and other factors as desired. In some aspects, as shown, the anti-rotation feature 680 can be a recess. In some aspects, the anti-rotation feature 680 can be a protrusion extending from a surrounding surface of the first portion 610 of the plug 360 and away from the second portion 620. In some aspects, as shown, the anti-rotation feature 680 can have rotational symmetry such that the tool 1200 can engage the anti-rotation feature 680 in more than one rotational position of the tool 1200 with respect to the plug 360. In some aspects, the anti-rotation feature 680 need not have rotational symmetry. In some aspects, the anti-rotation feature 680 will be anti-slip configuration, meaning that when either tightening or loosening the plug 360 or both tightening and loosening the plug 360 the anti-rotation feature 680 is designed to lockably receive the tool 1200, i.e., the tool does not slip out of the anti-rotation feature 680. In contrast, some tamper-proof fasteners such as a one-way fastener will lockably receive a tool in one direction (during tightening, for example) but any attempt to loosen the fastener will result in slippage of the tool. In some aspects, as shown, the anti-rotation feature 680 and the matching tool 1200 can define four “lobes” or portions that extend radially outward from the axis 601 of the plug 360. In some aspects, any number or “lobes” or no lobes can define at least a portion of the anti-rotation feature 680. In some aspects, the anti-rotation feature 680 can define one or more separate features configured to be separately but simultaneously engaged by the tool 1200 (again, as in the case of some tamper-proof fasteners). Where dimensions are shown in the figures, the absolute or relative dimensions can be other than as shown.

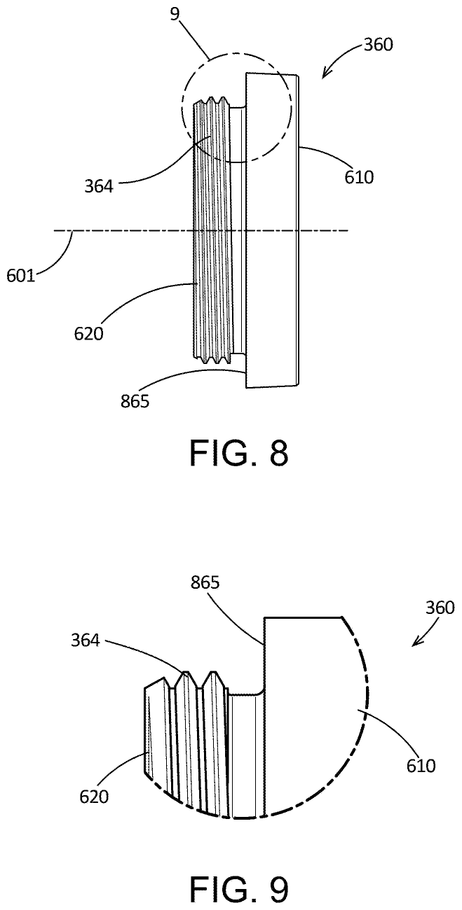

FIG. 8 is a side view of the plug 360 of FIG. 6, and FIG. 9 is a detail side view of the plug of FIG. 6 taken from detail 9 of FIG. 8. The plug 360 can define a shoulder 865 between the first portion 610 and the second portion 620. A surface defined by the shoulder 865 can face in an axial direction and, more specifically, can be angled 90 degrees with respect to the axis 601. As also shown in FIG. 9, for manufacturability or consistent installation or other reasons, the threaded portion 364 can terminate before reaching the first portion 610 or the shoulder 865 defined by the first portion 610. In some aspects, the threaded portion 364 can define National Pipe Straight Mechanical (NPSM) standard threads, which can facilitate flush alignment of surfaces of the plug 360 and a mating structure such as the inner cap 340 (shown in FIG. 5).

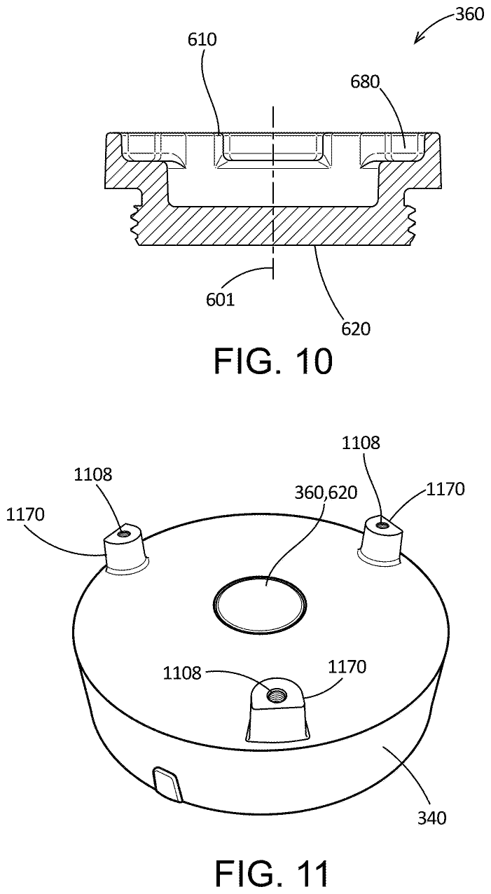

FIG. 10 is a sectional view of the plug 360 of FIG. 6 taken along line 10-10 of FIG. 7. As shown, a depth of the anti-rotation feature 680 can vary across the plug 360. For example and without limitation, a radially outer portion of the anti-rotation feature 680 can be shallower than a radially inner portion relative to the axis 601. Also as shown, some or all of an axial end surface of each of the first portion 610 and the second portion 620 can be flat and/or can be angled at 90 degrees with respect to the axis 601.

The plug 360 can be formed from a sufficiently rigid material to maintain its shape under the fluid pressures experienced inside a hydrant (e.g., a rating of at least 250 PSI). The plug 360 can be formed from a sufficiently rigid material to maintain its shape under the fluid pressures experienced during a hydrostatic testing at 700 PSI for five minutes or 1000 PSI for three minutes. The plug 360 can be formed from a polymer material. More specifically, the plug 360 can be formed from a polymer blend comprising polymer materials such as, for example and without limitation, polyphenylene ether (PPE) and polystyrene (PS). For example, in some aspects, the material forming the plug 360 can be glass-reinforced. An example of a specific material is NORYL GFN3 PPE+PS resin available from Sabic Innovative Plastics US LLC.

FIG. 11 is an outside perspective view of an outside end or second end of the inner cap 340 of the nozzle cap 1121 of FIG. 4. As shown, the second portion 620 of the plug 360 can sit flush or substantially flush with a surface of the second end of the inner cap 340. The inner cap can comprise one or more raised portions 1170, in which openings 1108 for the fasteners 390 (shown in FIG. 3A) can be defined.

FIG. 12 is an inside perspective view of an inside end or first end of the inner cap 340 of FIG. 11. Again, the tool 1200 (e.g., a drum wrench or bung wrench) can be used to remove or install the plug 360. More specifically, the tool 1200 can comprise a tool socket 1200a and a tool handle 1200b, which can be used for leverage. As shown, the shape of the anti-rotation feature 680 in the plug 360 can be shaped and otherwise configured to receive and lock a rotational position of the tool 1200 and, more specifically, the tool socket 1200a therewith and thereby install or remove the plug 360.

A method of assembly can comprise aligning one or more of the outer cap 310, the cover 320, the housing 330, the inner cap 340, the cap seal 350, and the plug 360 along the axis 301 of the nozzle cap 1121. The method can comprise assembling one or more of the outer cap 310, the cover 320, the housing 330, the inner cap 340, the cap seal 350, and the plug 360. The method can comprise assembling the one or more of the outer cap 310, the cover 320, the housing 330, the inner cap 340, the cap seal 350, and the plug 360 with one or more fasteners such as, for example and without limitations, the fasteners 390. The method can comprise positioning one or more of the outer cap 310, the cover 320, the housing 330, the inner cap 340, the cap seal 350, and the plug 360 in the order listed here. The method can comprise installing the plug 360 in the opening 348 defined in the inner cap 340. The method can comprise securing the nozzle cap 1121 to one of the nozzles 1120 of the hydrant 1000.

FIG. 13 is the hydrant of FIG. 1 in accordance with other aspects of the current disclosure and an electronic device 1380 (e.g., a smart phone) in communication the hydrant. A method of using the hydrant 1000 can comprise sending a signal from the sensing device 1300 of the hydrant 100. The sensing device 1300 can extend at least partly through the main valve or valve 1220 of the hydrant 1000. The method can comprise receiving the signal through the plug 360, formed from a non-metallic material and plugging the opening 348 defined in a portion (e.g., the inner cap 340) of the nozzle cap 1121 of the hydrant 1000 and securably engaged with the portion of the nozzle cap 1121. The method can comprise transmitting the signal from the communications hub 420 to an electronic device 1380.

A method of using the hydrant 1000 can comprise measuring a strength of a wireless signal received at the communications hub 420 from the sensing device 1300 positioned elsewhere in the hydrant 1000. More specifically, the sensing device 1300 can extend at least partly through the valve 1220 and, more specifically, the valve member 1250 of the hydrant 1000. The method can comprise determining whether the fluid (e.g., water) of the system is in the interior cavity 1006 of the hydrant 1000. If the strength of a wireless signal between the communications hub and the sensing device 1300 is reduced, this can indicate that the fluid is partially covering the antenna 1370 of the sensing device 1300. If the wireless signal is not detectable, the fluid has filled the interior cavity 1006 of the hydrant 1000. Reasons for a non-existent signal can include, for example and without limitation, the sensing device 1300 is no longer able to transmit a signal due to a dead or weak battery 1350, the hydrant 1000 is being used in a fire fighting activity, or the hydrant 1000 is faulty and is not draining. For any of these reasons, it can be beneficial for a user of the system to be notified and to be able to take action as appropriate.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A nozzle cap for a hydrant, the nozzle cap comprising:
an inner cap securably engageable with a nozzle of the hydrant, the nozzle configured to connect a fire hose to the hydrant;
a communications hub positioned adjacent to the inner cap; and
a plug plugging an opening defined in the inner cap and securably engaged with the inner cap, the plug comprising a material that allows transmission of a wireless signal through the material.

2. The nozzle cap of claim 1, wherein the plug comprises:
a first portion extending across the opening defined in the inner cap; and
a second portion extending from the first portion and securably engaged with the inner cap;
wherein the material is a non-metallic material.

3. The nozzle cap of claim 2, wherein the second portion defines a threaded portion received within a threaded portion defined in the inner cap.

4. The nozzle cap of claim 2, wherein a diameter of the second portion is smaller than a diameter of the first portion with respect to an axis of the plug.

5. The nozzle cap of claim 2, wherein the plug further comprises a third portion configured to extend away from each of the first portion and the second portion and towards an interior cavity of the hydrant, the third portion receiving an antenna of the communications hub in a cavity of the plug defined at least in part by the third portion thereof.

6. The nozzle cap of claim 1, wherein the plug defines an anti-rotation feature configured to be driven by a tool during installation or removal of the plug.

7. The nozzle cap of claim 1, further comprising a housing secured to the inner cap, the communications hub being positioned inside the housing.

8. The nozzle cap of claim 7, further comprising an outer cap secured to the housing, the outer cap comprising a protrusion configured to facilitate a tightening or a loosening of the nozzle cap during installation or removal of the nozzle cap.

9. The nozzle cap of claim 1, further comprising a seal configured to seal against passage of a fluid between the plug and the inner cap.

10. The nozzle cap of claim 9, wherein at least a portion of the seal is positioned between the plug and the inner cap.

11. The nozzle cap of claim 9, wherein the seal covers the plug on a size of the nozzle cap configured to face the nozzle.

12. A hydrant comprising:
a hydrant body; and
the nozzle cap of claim 1, the nozzle cap being selectively securable to the hydrant body.

13. The hydrant of claim 12, further comprising a sensing device, the sensing device extending at least partly through a main valve of the hydrant, the sensing device comprising a sensor configured to measure a property of a fluid contained within a system comprising the hydrant.

14. The hydrant of claim 13, wherein the sensor is configured to measure one of a pressure and a temperature of the fluid.

15. A method of using a hydrant, the method comprising:
sending a signal from a sensing device of the hydrant, the sensing device extending at least partly through a main valve of the hydrant; and
receiving the signal through a plug plugging an opening defined in a portion of a nozzle cap of the hydrant and securably engaged with the portion of the nozzle cap, the plug comprising a material that allows transmission of the signal through the material.

16. The method of claim 15, wherein the nozzle cap is configured to connect a fire hose to the hydrant.

17. The method of claim 15, wherein the signal is a wireless signal.

18. A method of using a hydrant in a fluid distribution system, the method comprising:
measuring a strength of a wireless signal received at a communications hub positioned in a nozzle cap of the hydrant from a sensing device positioned elsewhere in the hydrant; and
determining whether a fluid intended to be distributed in the fluid distribution system is in an interior cavity of the hydrant based on the strength of the wireless signal.

19. The method of claim 18, further comprising receiving the wireless signal through a plug plugging an opening defined in the nozzle cap, the plug comprising a material that allows transmission of the wireless signal through the material.

20. The method of claim 18, wherein measuring the strength of the wireless signal received at the communications hub positioned in the nozzle cap of the hydrant comprises measuring the strength of the wireless signal received at the communications hub from a sensing device extending at least partly through a main valve of the hydrant.
